(19) United States
(12) Patent Application Publication
(10) Pub. No.: US 2017/0072394 A1
(43) Pub. Date: Mar. 16, 2017

(54) LIDS FOR CONTROLLING EVAPORATION

(71) Applicants: Namyong KIM, Palo Alto, CA (US); CURIOX BIOSYSTEMS PTE LTD., Singapore (SG)

(72) Inventor: Namyong KIM, Palo Alto, CA (US)

(21) Appl. No.: 15/125,351

(22) PCT Filed: Mar. 10, 2015
(86) PCT No.: PCT/US15/19760

§ 371 Date: Sep. 12, 2016

Related U.S. Application Data
(60) Provisional application No. 61/950,626, filed on Mar. 10, 2014.

(51) Int. Cl. B01L 3/00; B65B 7/28

(52) U.S. Cl. CPC B01L 3/50853; B65B 7/28; B01L 2200/142; B01L 2300/0829; B01L 2300/048; B01L 2300/089; B01L 2300/161

(57) ABSTRACT

A lid for controlling evaporation of liquid aliquots is disclosed. In some embodiments, the lid includes a cover plate configured to cover at least a portion of a sample plate. The cover plate has a bottom surface configured to face the sample plate. The lid also includes one or more evaporators coupled to the bottom surface of the cover plate. Each evaporator of the one or more evaporators includes absorbent material, and the one or more evaporators define one or more exclusion areas on the bottom surface of the cover plate. Each exclusion area is exposed from the one or more evaporators.

### TECHNICAL FIELD

The disclosed embodiments relate generally to lids for controlling evaporation of liquid aliquots on sample plates, and methods for making and using the same. More particularly, the disclosed embodiments relate to lids for controlling evaporation of liquid aliquots that contain biological and/or chemical reagents, and methods for making and using the same.

### BACKGROUND

A sample plate, which typically includes a microtiter plate, microplate, or microwell plate, is typically used to hold respective liquid aliquots separately for biological and/or chemical reaction. For example, a well-type sample plate includes an array of wells so that each liquid aliquot or each sample may be dispensed into a separate well for further processing. Typically, the number of wells is selected from 6, 24, 96, 384, 1536, 3456, and 9600. Alternatively, low-profile sample plates, such as slides, include a plurality of generally flat areas on which liquid aliquots may be dispensed for further processing.

In an ambient environment, liquid aliquots placed on the sample plate evaporate over time and change concentrations of biological and/or chemical reagents in the liquid aliquots, which can adversely influence reactions and/or assays. For example, concentrations of biological and/or chemical reagents change over time, which leads to inaccurate reaction and/or assay results depending on time during which the liquid aliquots are left to evaporate. In addition, liquid aliquots located around a periphery of the sample plate have higher evaporation rates (e.g., evaporate faster) than liquid aliquots located in a middle of the sample plate, and as a result, concentrations of reagents in liquid aliquots change at different rates. For example, concentrations of biological and/or chemical reagents change more rapidly in liquid aliquots located around a periphery of the sample plate, which leads to variations and errors depending on the location of an aliquot. Such differences in evaporation rates are more significant with low-profile sample plates, thereby increasing variations in reactions and/or assays. Conventional lids are not effective at controlling evaporation of liquid aliquots on sample plates and, in particular, on low-profile sample plates.

### SUMMARY

Accordingly, there is need for lids (also called covers) that control evaporation of liquid aliquots on sample plates. Such lids may replace the conventional lids in covering sample plates. Such lids reduce the variations in evaporation rates, thereby improving the uniformity of reactions and/or assays on sample plates.

As used herein, a liquid aliquot (also called herein a liquid droplet) refers to a volume of a liquid. A liquid aliquot may have any shape. For example, in some embodiments, when the liquid aliquot is placed on a sample plate, the liquid aliquot has a semispherical shape.

A number of embodiments that overcome the limitations and disadvantages of existing lids are presented in more detail below. These embodiments provide lids for controlling evaporation of liquid aliquots on sample plates and methods for making and using the same.

As described in more detail below, in accordance with some embodiments, a lid for controlling evaporation of liquid aliquots includes a cover plate configured to cover at least a portion of a sample plate. The cover plate has a bottom surface configured to face the sample plate. The lid also includes one or more evaporators coupled to the bottom surface of the cover plate. Each evaporator of the one or more evaporators includes absorbent material. The one or more evaporators define one or more exclusion areas on the bottom surface of the cover plate. Each exclusion area is exposed from the one or more evaporators.

In some embodiments, each evaporator of the one or more evaporators is an absorbent pad.

In some embodiments, the one or more evaporators define a single exclusion area at least in a middle portion of the bottom surface of the cover plate.

In some embodiments, the one or more evaporators define a single exclusion area at a location that corresponds to a middle portion of the sample plate.

In some embodiments, the lid includes only one evaporator that has a through-hole defining a single exclusion area in a middle portion of the bottom surface of the cover plate.

In some embodiments, the lid is configured to cover a rectangular sample plate and the single exclusion area is a rectangular area.

In some embodiments, the one or more evaporators are positioned along a periphery of the bottom surface of the cover plate.

In some embodiments, each evaporator of the one or more evaporators comprises water absorbent material.

In some embodiments, each evaporator of the one or more evaporators has a top surface facing the cover plate and an exposed bottom surface opposite to the top surface.

In some embodiments, the bottom surface of the one or more evaporators is fully exposed to air.

In some embodiments, at least 25% of the bottom surface of the one or more evaporators is exposed to air.

In some embodiments, at least 50% of the bottom surface of the one or more evaporators is exposed to air.

In some embodiments, at least 75% of the bottom surface of the one or more evaporators is exposed.

In some embodiments, the lid includes one or more screens located adjacent to the bottom surface of the cover plate, the one or more screens covering at least a portion of the bottom surface of the one or more evaporators.

In some embodiments, at least one exclusion area of the one or more exclusion areas is located adjacent to a center of the bottom surface of the cover plate.

In some embodiments, at least one exclusion area of the one or more exclusion areas is located along, and adjacent to, a periphery of the bottom surface of the cover plate.

In some embodiments, the one or more evaporators are configured to avoid, when the lid is placed on the sample plate, a contact with the sample plate. In some embodiments, the one or more evaporators are positioned to avoid a contact with the sample plate when the lid is placed on the sample plate. In some embodiments, at least a portion of the one or more evaporators is covered to avoid a contact with the sample plate when the lid is placed on the sample plate.

In some embodiments, at least a portion of the cover plate is transparent.

In some embodiments, the cover plate defines one or more through-holes. Each through-hole extends from a top surface, opposite to the bottom surface, of the cover plate to the bottom surface of the cover plate and coupled to at least a portion of an evaporator of the one or more evaporators.

In some embodiments, the one or more through-holes are positioned along a periphery of the cover plate.

In some embodiments, the one or more through-holes are positioned adjacent to a corner of the cover plate.

In some embodiments, the lid includes one or more barriers on the top surface of the cover plate configured to cover the one or more through-holes.

In some embodiments, the lid includes a coupler, the coupler being in contact with the one or more evaporators.

In some embodiments, the cover plate is configured to couple with a removable coupler. The removable coupler is in contact with the one or more evaporators when the removable coupler is coupled with the cover plate.

In some embodiments, each evaporator of the one or more evaporators comprises one or more of cellulose, paper, cotton, polyvinyl alcohol, hydrogel, polyacrylamide gel, and agarose gel.

In accordance with some embodiments, a lid for controlling evaporation of liquid aliquots includes a cover plate configured to cover at least a portion of a sample plate. The cover plate has a bottom surface configured to face the sample plate. The lid also includes one or more evaporators coupled to the bottom surface of the cover plate. Each evaporator of the one or more evaporators includes absorbent material. The lid further includes one or more screens located adjacent to the bottom surface of the cover plate. The one or more screens cover at least a portion of the bottom surface of the one or more evaporators.

In accordance with some embodiments, an applicator device for providing a evaporation solution to any lid described above includes one or more absorbent pads sized and positioned to contact the one or more evaporators of the lid when the applicator device is coupled with the lid. The applicator device is configured to removably couple with the lid.

In some embodiments, the one or more absorbent pads include the evaporation solution.

In accordance with some embodiments, a lid configured for use with a sample plate that includes one or more side walls and one or more inner walls. The lid includes a cover plate configured to cover at least a portion of a sample plate, the cover plate having a bottom surface configured to face the sample plate and one or more contact portions configured to contact with the sample plate when the lid is placed on the sample plate; and one or more evaporators coupled to the bottom surface of the cover plate, each evaporator of the one or more evaporators comprising absorbent material. A vertical distance between a respective contact portion of the one or more contact portions and the bottom surface of the cover plate satisfy predefined criteria.

In some embodiments, the predefined criteria are satisfied when the vertical distance is 2 mm or more.

In some embodiments, the predefined criteria are satisfied when the vertical distance is 5 mm or more.

In accordance with some embodiments, a combination of a lid and a sample plate. The combination includes a sample plate that includes one or more side walls and one or more inner walls; and a lid that includes a cover plate, one or more contact portions configured to contact with the sample plate when the lid is placed on the sample plate, and one or more evaporators coupled to the bottom surface of the cover plate, each evaporator of the one or more evaporators comprising absorbent material. A distance between a top surface of the one or more inner walls of the sample plate and the bottom surface of the cover plate satisfy predefined criteria.

In some embodiments, the predefined criteria are satisfied when the vertical distance is 2 mm or more.

In some embodiments, the predefined criteria are satisfied when the vertical distance is 5 mm or more.

In accordance with some embodiments, a sample plate includes one or more side walls configured to couple with any lid described above; and one or more inner walls configured such that a distance between the one or more inner walls and the lid satisfies predefined criteria.

In some embodiments, the distance between the one or more inner walls and the lid is 2 mm or more.

In some embodiments, the distance between the one or more inner walls and the lid is 5 mm or more.

In some embodiments, a height of the one or more inner walls is less than a height of the one or more side walls.

In addition, methods for assembling and using any lid described above are described in detail below.

### BRIEF DESCRIPTION OF THE DRAWINGS

For a better understanding of the aforementioned embodiments as well as additional embodiments, reference should be made to the Description of Embodiments below, in conjunction with the following drawings in which like reference numerals refer to corresponding parts throughout the figures.

FIG. 1 is perspective views of an exemplary sample plate in accordance with some embodiments.

FIGS. 2A-2B are cross-sectional views of an exemplary combination of a sample plate and a lid in accordance with some embodiments.

FIG. 2C is a cross-sectional view of an exemplary combination of a sample plate and a lid in accordance with some embodiments.

FIG. 3A is a cross-sectional view of an exemplary combination of a sample plate and a lid in accordance with some embodiments.

FIG. 3B is a cross-sectional view of an exemplary combination of a sample plate and a lid in accordance with some embodiments.

FIG. 3C is a cross sectional view of an exemplary combination of a sample plate and a lid in accordance with some embodiments.

FIG. 3D is a cross sectional view of an exemplary combination of a sample plate and a lid in accordance with some embodiments.

FIG. 3E is a cross sectional view of an exemplary combination of a sample plate and a lid in accordance with some embodiments.

FIG. 3F is a cross sectional view of an exemplary combination of a sample plate and a lid in accordance with some embodiments.

FIG. 4 is a perspective view of an exemplary lid in accordance with some embodiments.

FIGS. 5A-5D are bottom views of exemplary lids in accordance with some embodiments.

FIG. 6A is an exploded view of an exemplary lid in accordance with some embodiments.

FIG. 6B is an exploded view of an exemplary lid in accordance with some embodiments.

FIG. 6C is an exploded view of an exemplary lid in accordance with some embodiments.

FIG. 7A is a cross sectional view of an exemplary combination of a sample plate and a lid in accordance with some embodiments.

FIG. 7B is a cross sectional view of an exemplary combination of a sample plate and a lid in accordance with some embodiments.

FIG. 8 is a cross sectional view of an exemplary combination of a sample plate, a lid, and an applicator device in accordance with some embodiments.

FIG. 9 is a flow chart representing a method of assembling a lid in accordance with some embodiments.

FIGS. 10A and 10B are flow charts representing a method of using a lid in accordance with some embodiments.

Like reference numerals refer to corresponding parts throughout the drawings.

### DESCRIPTION OF EMBODIMENTS

Lids, and methods for making and using the lids, are described. Reference will be made to certain embodiments, examples of which are illustrated in the accompanying drawings. While the claims will be described in conjunction with the embodiments, it will be understood that it is not intended to limit the claims to these particular embodiments alone. On the contrary, the embodiments are intended to cover alternatives, modifications and equivalents that are within the spirit and scope of the appended claims.

Moreover, in the following description, numerous specific details are set forth to provide a thorough understanding of the embodiments. However, it will be apparent to one of ordinary skill in the art that the embodiments may be practiced without these particular details. In other instances, methods, procedures, components, and networks that are well-known to those of ordinary skill in the art are not described in detail to avoid obscuring aspects of the embodiments.

It will also be understood that, although the terms first, second, etc. may be used herein to describe various elements, these elements should not be limited by these terms. These terms are only used to distinguish one element from another. For example, a first concentration could be termed a second concentration, and, similarly, a second concentration could be termed a first concentration, without departing from the scope of the embodiments. The first concentration and the second concentration are both concentrations, but they are not necessarily the same concentration.

The terminology used in the description of the embodiments herein is for the purpose of describing particular embodiments only and is not intended to be limiting of the invention. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

### Sample Plates

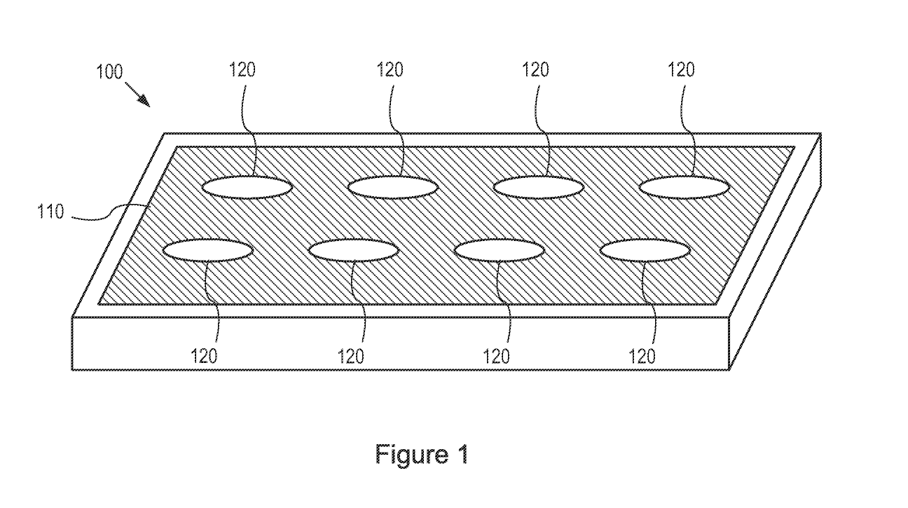

FIG. 1 is a perspective view of an exemplary sample plate 100 in accordance with some embodiments. The exemplary sample plate 100 includes an array of sample regions 120. In some embodiments, the sample regions 120 are surrounded by one or more surrounding region 110. In some embodiments, the sample regions 120 are hydrophilic regions. In some embodiments, the surrounding region 110 is a hydrophobic region. In some embodiments, the surrounding region 110 is a hydrophilic region. In some embodiments, the hydrophilic and hydrophobic regions are formed by using different materials (e.g., hydrophilic material for the hydrophilic regions and hydrophobic material for hydrophobic regions). In some embodiments, the hydrophilic and hydrophobic regions are formed by chemically or physically treating a surface.

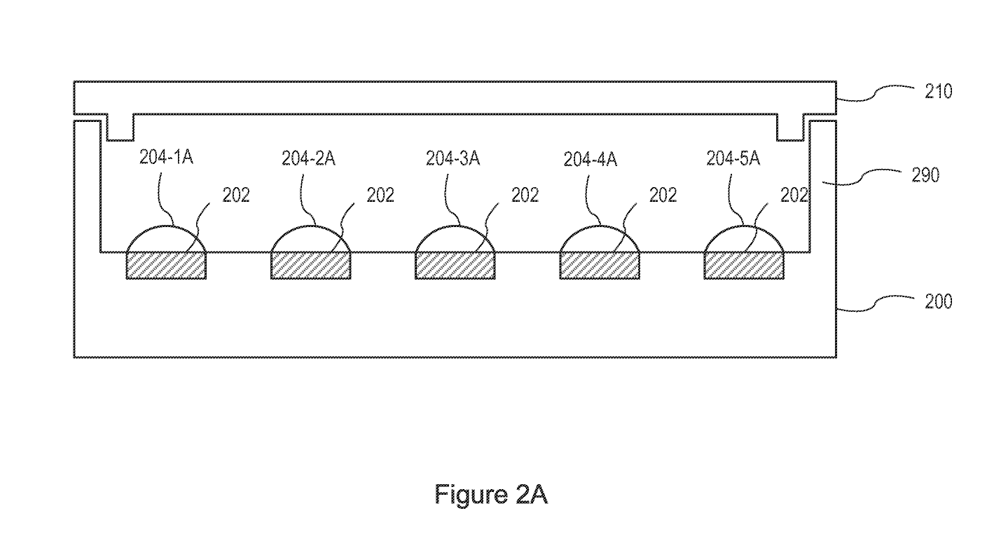

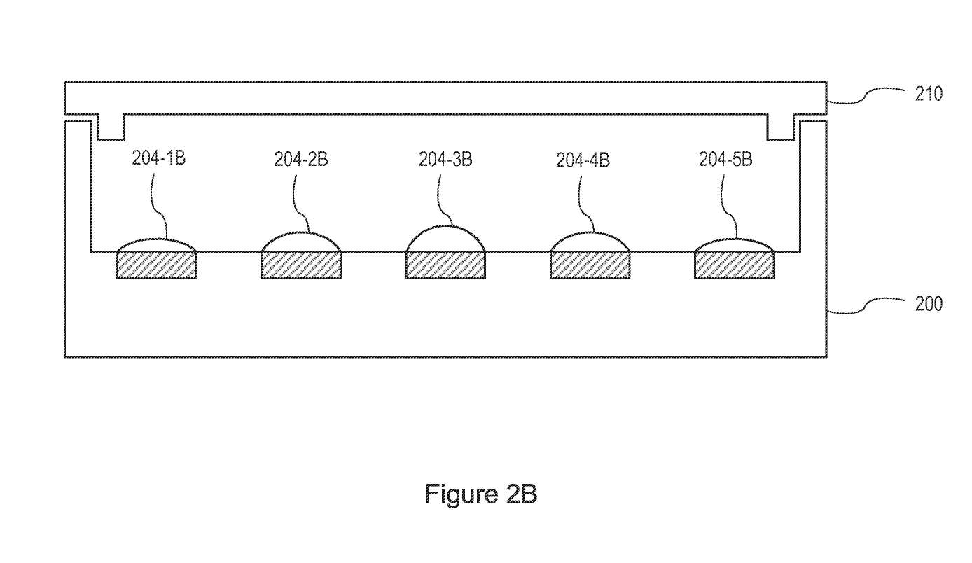

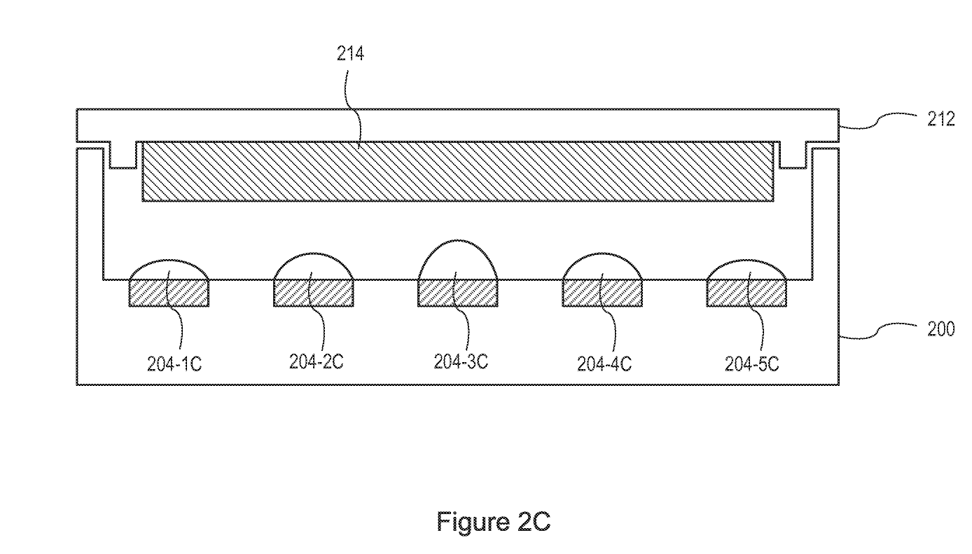

In some embodiments, as illustrated in FIG. 1, the exemplary sample plate 100 has a flat continuous surface. In some other embodiments, a sample plate includes an array of wells. In some embodiments, a sample plate includes one or more side walls (e.g., as illustrated in FIGS. 2A-2B, which are described below).

FIGS. 2A-2B are cross-sectional views of an exemplary combination of a sample plate and a lid in accordance with some embodiments.

In FIG. 2A, a sample plate 200 includes hydrophilic material that defines an array of sample regions 202. In some embodiments, the sample plate 200 includes side walls 290.

FIG. 2A also illustrates that liquid aliquots 204 (e.g., sample solutions) are deposited on sample regions 202. For example, a liquid aliquot 204-1A, a liquid aliquot 204-2A, a liquid aliquot 204-3A, a liquid aliquot 204-4A, and a liquid aliquot 204-5A are deposited on respective sample regions 202 of the sample plate 200. In FIG. 2A, the liquid aliquot 204-1A, the liquid aliquot 204-2A, the liquid aliquot 204-3A, the liquid aliquot 204-4A, and the liquid aliquot 204-5A have the same volume.

In some embodiments, the sample plate 200 and the liquid aliquots 204 on the sample plate 200 are incubated (e.g., maintained for a particular period of time without adding a reagent to a liquid aliquot, such as hours or days). For example, when the liquid aliquots include cells, the liquid aliquots are incubated for several days in some embodiments.

However, over the period of incubation, solvents in the liquid aliquots (e.g., water) can evaporate. In particular, the evaporation is more significant when the liquid aliquots are small (e.g., a liquid aliquot having a volume of 20 μL).

FIG. 2B illustrates that, over the period of incubation, the liquid aliquots have less volumes due to an evaporation of solvents in the liquid aliquots. For example, liquid aliquots 204-1B, 204-2B, 204-4B, and 204-5B have less volume than the liquid aliquots before the incubation (cf, the volume of liquid aliquots 204-1A, 204-2A, 204-4A, and 204-5A illustrated in FIG. 2A).

In some embodiments, liquid aliquots located near an edge of the sample plate 200 evaporate more than liquid aliquots located near a middle of the sample plate 200 during the incubation. For example, as illustrated in FIG. 2B, liquid aliquots 204-1B and 204-5B, located near edges of the sample plate 200, have less volumes than liquid aliquot 204-3B, located near a middle of the sample plate 200.

FIG. 2C is a cross-sectional view of an exemplary combination of a sample plate and a lid in accordance with some embodiments.

FIG. 2C illustrates that a lid 212 includes an absorbent pad 214. The absorbent pad 214 extends over a substantial portion of the sample plate. For example, the absorbent pad 214 illustrated in FIG. 2C extends over the sample regions. When the absorbent pad 214 has absorbed a solvent, the solvent in the absorbent pad 214 evaporates during the incubation, thereby reducing evaporation of liquid aliquots. However, the absorbent pad 214 does not prevent a variation in evaporation rates of a solvent in liquid aliquots based on locations of the liquid aliquots. As illustrated in FIG. 2C, liquid aliquots located near an edge of the sample plate 200 evaporate more than liquid aliquots located near a middle of the sample plate 200 during the incubation. In addition, a liquid aliquot located near a middle of the sample plate 200 (e.g., a liquid aliquot 204-3C) may increase its volume during the incubation due to the migration of the solvent molecules that have evaporated from the absorbent pad 214, thereby further increasing the variation in the liquid aliquot volumes during the incubation.

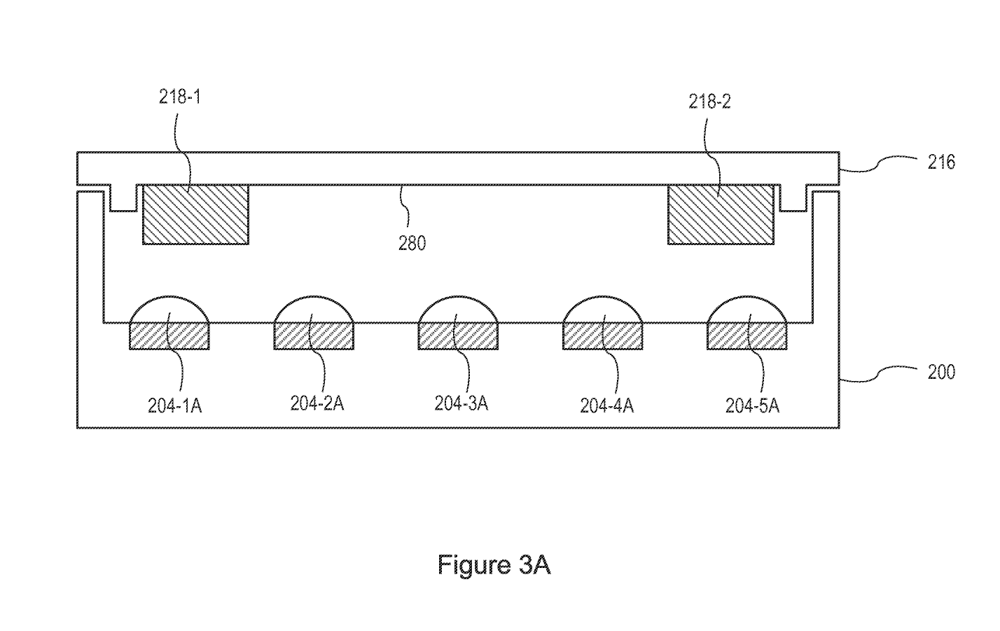

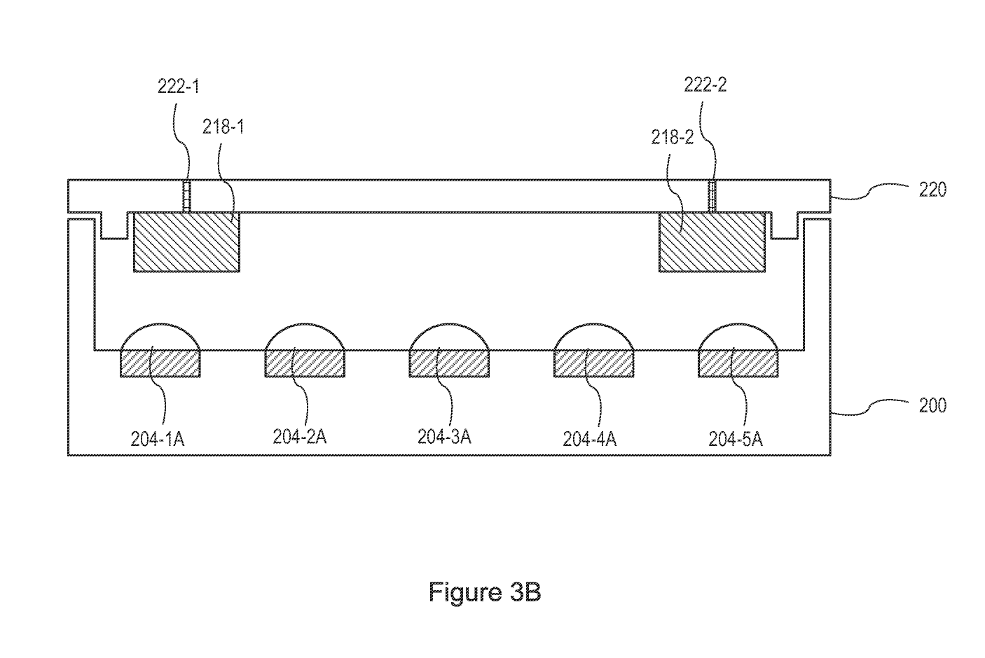

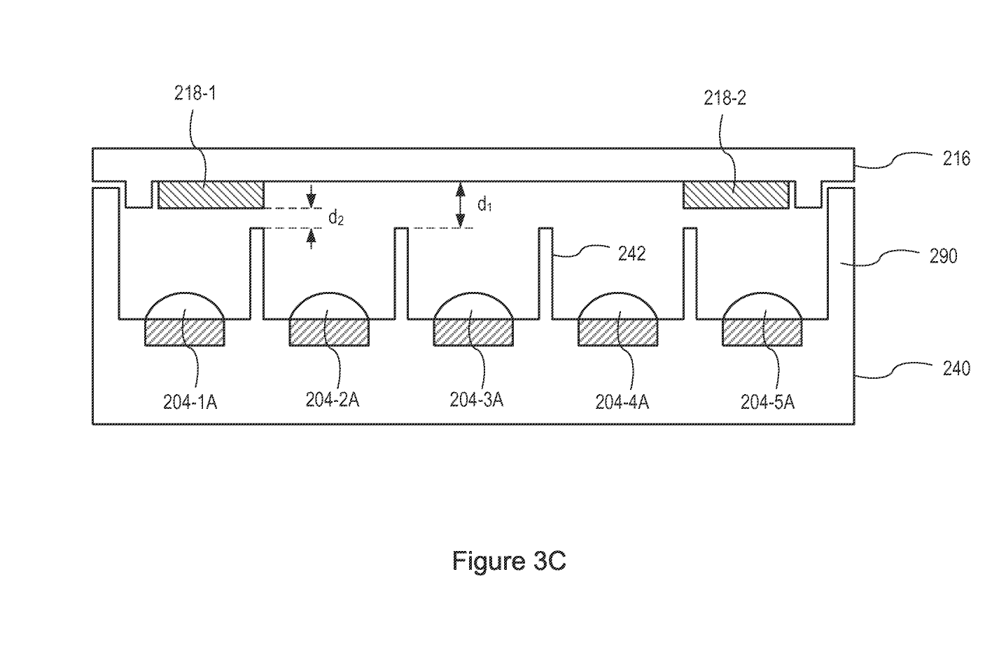

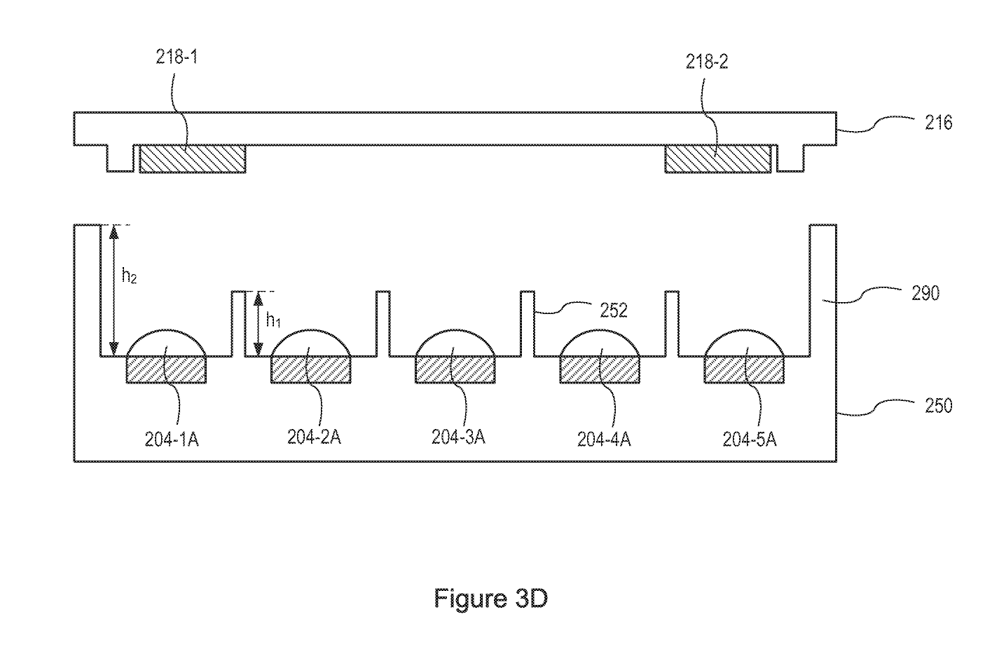

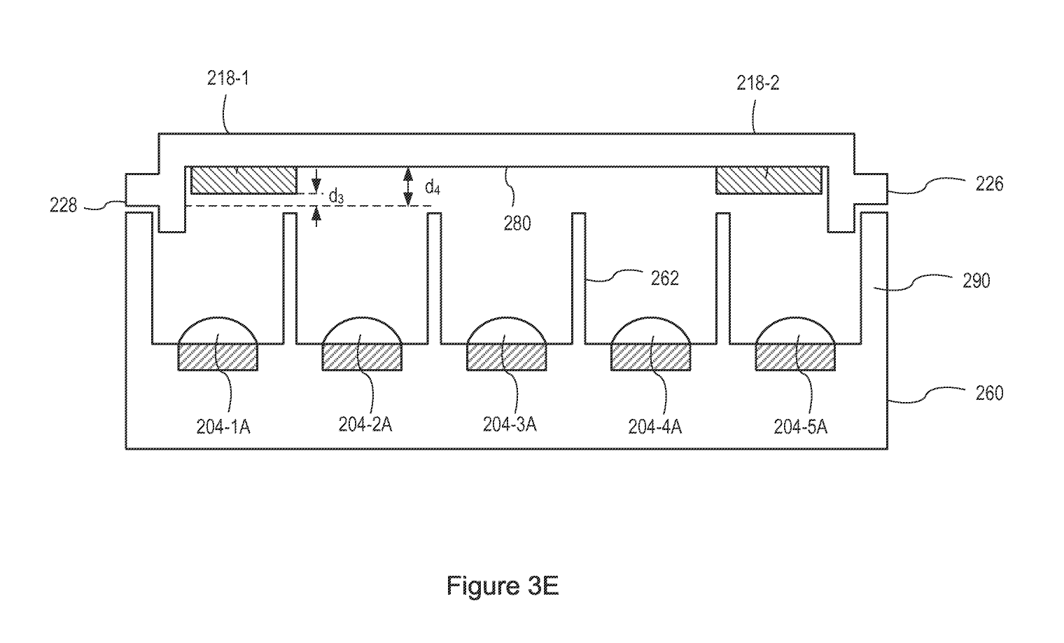

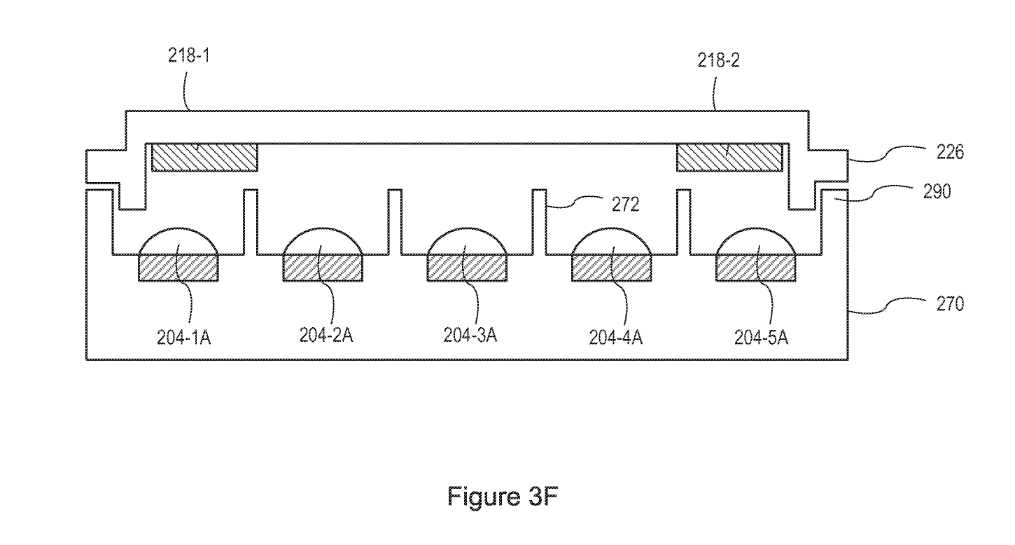

FIG. 3A is a cross-sectional view of an exemplary combination of a sample plate and a lid in accordance with some embodiments.

The sample plate 200 and the liquid aliquots 204 illustrated in FIG. 3A are similar to those described above with respect to FIG. 2A. For brevity, the description of these elements is not repeated.

FIG. 3A also illustrates a lid 216 that includes one or more evaporators (e.g., evaporators 218-1 and 218-2). The one or more evaporators are coupled to the bottom surface 280 of the lid 216. As used herein, a bottom surface 280 of the lid refers to a surface of the lid 216 that faces the sample plate 200, and a top surface of the lid 216 refers to a surface of the lid 216 opposite to the bottom surface 280 of the lid 216. As illustrated in FIG. 3A, the one or more evaporators 218 define an exclusion area (e.g., an area on the bottom surface of the lid 216 between the evaporators 218-1 and 218-2). The exclusion area is exposed from the one or more evaporators (e.g., the exclusion area is not covered with the one or more evaporators).

In some embodiments, the one or more evaporators are attached to the bottom surface of the lid. In some embodiments, the one or more evaporators are attached to the bottom surface of the lid with an adhesive (e.g., an adhesive tape). In some embodiments, at least one of the one or more evaporators is attached to the bottom surface of the lid with an adhesive. In some embodiments, the one or more evaporators are wet (e.g., with an aqueous solution), and the one or more evaporators are attached to the bottom surface of the lid by hydrophilic interaction. In some embodiments, at least one of the one or more evaporators is attached to the bottom surface of the lid by hydrophilic interaction.

FIG. 3B is a cross-sectional view of an exemplary combination of a sample plate and a lid in accordance with some embodiments. The sample plate 200 and the liquid aliquots 204 illustrated in FIG. 3B are similar to those described above with respect to FIG. 2A. For brevity, the description of these elements is not repeated.

FIG. 3B also illustrates a lid 220. The lid 220 is similar to the lid 216 illustrated in FIG. 216. In addition, one or more through-holes (e.g., through-holes 222-1 and 222-2) are defined in the lid 220. In FIG. 3B, a through-hole extends from a top surface of the lid 220 to a bottom surface of the lid 220, and is coupled to at least a portion of an evaporator (e.g., evaporator 218-1 and evaporator 218-2). The through-hole need not be a straight hole. For example, in some embodiments, the through-hole has a varying diameter along the through-hole. In some embodiments, the through hole has one or more bends or curves along the length of the through-hole. In some embodiments, the one or more through-holes are positioned along a periphery of the cover plate. In some embodiments, the one or more through-holes are positioned adjacent to a corner of the cover plate. In some embodiments, the one or more through-holes are used to supply a solvent to the one or more evaporators. In some embodiments, the lid includes one or more barriers, on the top surface, configured to cover the one or more through-holes. The one or more barriers reduce evaporation of the solvent through the one or more through-holes. In some embodiments, the one or more barriers are made of a material impermeable by the solvent (e.g., stainless steel, plastic, rubber, etc.). In some embodiments, supplying a solvent to the one or more evaporators includes moving the one or more barriers to expose the one or more through-holes prior to providing the solvent to the one or more evaporators, and moving the one or more barriers back to cover the one or more through-holes subsequent to providing the solvent to the one or more evaporators.

FIG. 3C is a cross sectional view of an exemplary combination of a sample plate and a lid in accordance with some embodiments.

The liquid aliquots 204 illustrated in FIG. 3C are similar to those described above with respect to FIG. 2A. The lid 216 illustrated in FIG. 3C is similar to the lid described above with respect to FIG. 3A. For brevity, the description of these elements is not repeated.

A sample plate 240 in FIG. 3C is similar to the sample plate 200 described above with respect to FIG. 2A except that the sample plate 240 includes one or more inner walls 242. For example, in some embodiments, the sample plate 240 is a well-type sample plate (also called herein a well plate). In some embodiments, the inner walls 242 are shorter than the side walls 290. This facilitates delivery of water molecules to the liquid aliquots 204 over the entire sample plate 240.

The inventor of this application has found that the evaporators 218 are also effective in improving the consistency in evaporation rates for the sample aliquots 204 when a distance between the top of the inner walls 242 satisfies predefined condition. In some embodiments, distance d₁ between the top of the inner walls and a bottom surface of the lid 216 is used as a representative distance. In some embodiments, distance d₂ between the top of the inner walls and a bottom surface of the evaporator 218 is used as a representative distance. In some embodiments, the distance is 2 mm or more. In some embodiments, the distance is 5 mm or more.

FIG. 3D is a cross sectional view of an exemplary combination of a sample plate and a lid in accordance with some embodiments. The lid 216 is as described above with respect to FIGS. 3A and 3C. For brevity, the description of the lid 216 is not repeated herein.

FIG. 3D shows that height h₁ of the inner walls 252 is less than height h₂ of the side walls 290 to provide the distance between the top of the inner walls and the bottom surface of the lid (or the bottom surface of the evaporator 218). In some embodiments, the height h₁ of the inner walls 252 is one half of the height h₂ of the side walls 290.

FIG. 3E is a cross sectional view of an exemplary combination of a sample plate and a lid in accordance with some embodiments.

FIG. 3E illustrates a conventional sample plate (e.g., microwell plate) 260. In some embodiments, the sample plate 260 includes hydrophilic regions each surrounded by a hydrophobic region. In some embodiments, the sample plate 260 does not include a combination of hydrophilic regions and one or more hydrophobic regions (e.g., the entire sample plate 260 may be hydrophilic). In FIG. 3E, inner walls 262 and side walls 290 have a substantially same height (e.g., the heights differ by less than 5% of a representative height).

For the conventional sample plate 260, a lid 216 (e.g., FIG. 3D) may not be compatible. For example, the evaporators 218 may come into contact with the inner walls 262 if the lid 216 were to be used to cover the sample plate 260, thereby interfering with covering the sample plate 260 with the lid 216. This will lead to increased gaps through which the moisture can escape, and the evaporation of the solutions on the sample plate 260 will be increased. In addition, the distance between the evaporators 218 and the top of the inner walls 262 may not be sufficient (e.g., less than 2 mm).

FIG. 3E also illustrates a lid 226. One or more contact portions 228 of the lid 226, which are configured to come into contact with the sample plate 260 when the lid 226 is placed on the sample plate 260, are configured such that distance d₄ between a plane defined by the one or more contact portions 228 and a plane defined by the bottom surface 280 of the lid 226 satisfies predefined criteria when the lid 226 is placed on the sample plate 260. In some embodiments, the one or more contact portions 228 of the lid 226 are configured such that distance d₄ between the plane defined by the one or more contact portions 228 and a plane defined by a bottom surface of the evaporators 218 satisfies the predefined criteria. In some embodiments, the predefined criteria are satisfied when the distance d₃ or d₄ is 2 mm or more. In some embodiments, the predefined criteria are satisfied when the distance d₃ or d₄ is 5 mm or more.

FIG. 3F is a cross sectional view of an exemplary combination of a sample plate and a lid in accordance with some embodiments.

FIG. 3F illustrates the lid 226. The lid 226 is as described above with respect to FIG. 3E. For brevity, the description of the lid 226 is not repeated herein. FIG. 3F illustrates that the lid 226 may also be used with a sample plate 270 of a different height.

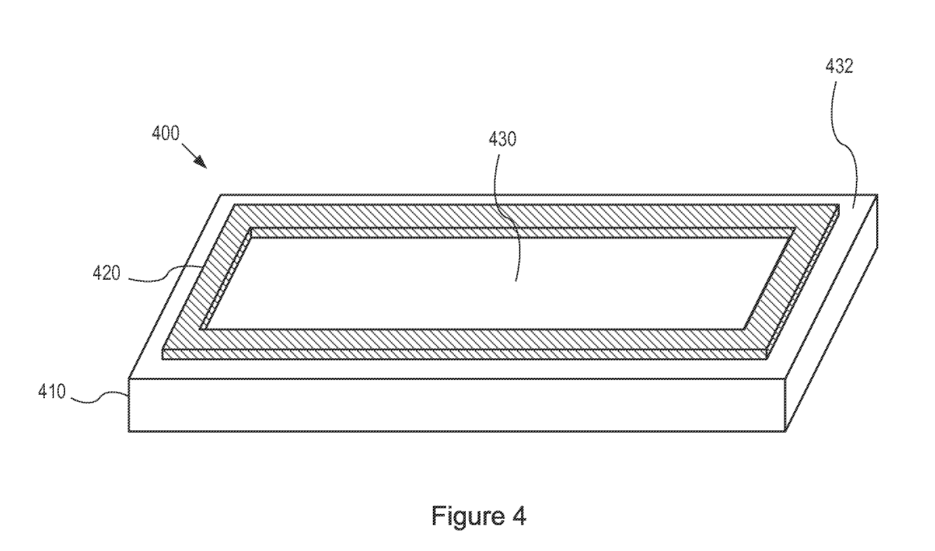

FIG. 4 is a perspective view of an exemplary lid 400 in accordance with some embodiments.

In some embodiments, as shown in FIG. 4, the lid 400 includes a cover plate 410 that is configured to cover at least a portion of a sample plate. In some embodiments, the cover plate 410 is configured to cover the sample plate entirely. The cover plate 410 has a surface (also called herein a bottom surface) configured to face the sample plate. The lid 400 includes one or more evaporators (e.g., evaporator 420) coupled to the bottom surface of the cover plate 410. Each evaporator of the one or more evaporators includes absorbent material. In some embodiments, each evaporator of the one or more evaporators is an absorbent pad. In some embodiments, each evaporator of the one or more evaporators includes water absorbent material. In some embodiments, each evaporator of the one or more evaporators includes one or more of cellulose, paper, cotton, polyvinyl alcohol, hydrogel, polyacrylamide gel, and agarose gel.

As illustrated in FIG. 4, in some embodiments, the one or more evaporators (e.g., evaporator 420) define one or more exclusion areas (e.g., an exclusion area 430) on the bottom surface of the cover plate. Each exclusion area is exposed from the one or more evaporators (e.g., each exclusion area is not covered by the one or more evaporators).

In some embodiments, the one or more evaporators define a single exclusion area 430 at least in a middle portion of the bottom surface of the cover plate. In some embodiments, the one or more evaporators (e.g., evaporator 420) define a single exclusion area 430 at a location that corresponds to a middle portion of the sample plate. In some embodiments, the lid includes only one evaporator 420 that has a through-hole defining a single exclusion area 430 in a middle portion of the bottom surface of the cover plate. In some embodiments, the single exclusion area 430 is a rectangular area. Alternatively, the single exclusion area may have a different shape (e.g., an oval, a circle, a diamond, etc.).

In some embodiments, at least one exclusion area (e.g., exclusion area 430) of the one or more exclusion areas is located adjacent to a center of the bottom surface of the cover plate, as illustrated in FIG. 4.

In some embodiments, at least one exclusion area of the one or more exclusion areas is located along, and adjacent to, a periphery of the bottom surface of the cover plate. For example, the area 432 located along, and adjacent to, a periphery of the bottom surface of the cover plate 410 is not covered by one or more evaporators.

In some embodiments, at least a portion of the cover plate is transparent. For example, in some embodiments, at least a portion of the cover plate 410 that corresponds to the exclusion area 430 is transparent. This allows a user of the lid to visually inspect the sample plate (or liquid aliquots on the sample plate) through the transparent portion of the cover plate 410. In some embodiments, an evaporator of the one or more evaporators is transparent. In some embodiments, at least one evaporator of the one or more evaporators is transparent. In some embodiments, the one or more evaporators are transparent.

In some embodiments, the one or more evaporators are configured to avoid, when the lid is placed on the sample plate, a contact with the sample plate. In some embodiments, the one or more evaporators are positioned to avoid a contact with the sample plate when the lid is placed on the sample plate. For example, in some embodiments, a distance from an edge of the bottom surface of the cover plate 410 to the evaporator 420 is selected so that the evaporator 420 does not come in contact with the sample plate (e.g., a side wall of the sample plate) when the lid is placed over the sample plate. In some embodiments, the distance is selected so that the evaporator 420 does not come in contact with the sample plate when the lid moves over the sample plate. For example, a typical lid is configured to have a tolerance that allows a movement of the lid over the sample plate (e.g., by 0.2-2 millimeters). This facilitates a mating of the lid and the sample plate. In some embodiments, the distance is selected based on the tolerance. In some embodiments, at least a portion of the one or more evaporators is covered to avoid a contact with the sample plate when the lid is placed on the sample plate.

In some embodiments, the lid 400 is configured to cover a rectangular sample plate. For example, the lid 400 illustrated in FIG. 4 has a rectangular shape. In some embodiments, as illustrated in FIG. 4, the one or more evaporators are positioned along a periphery of the bottom surface of the cover plate.

In some embodiments, each evaporator of the one or more evaporators has a top surface facing the cover plate and an exposed bottom surface opposite to the top surface. For example, as illustrated in FIG. 4, the bottom surface of the evaporator 420 is not covered. This allows the bottom surface of the evaporator 420 to be fully exposed to air, thereby allowing evaporation of a solvent through the bottom surface of the evaporator 420.

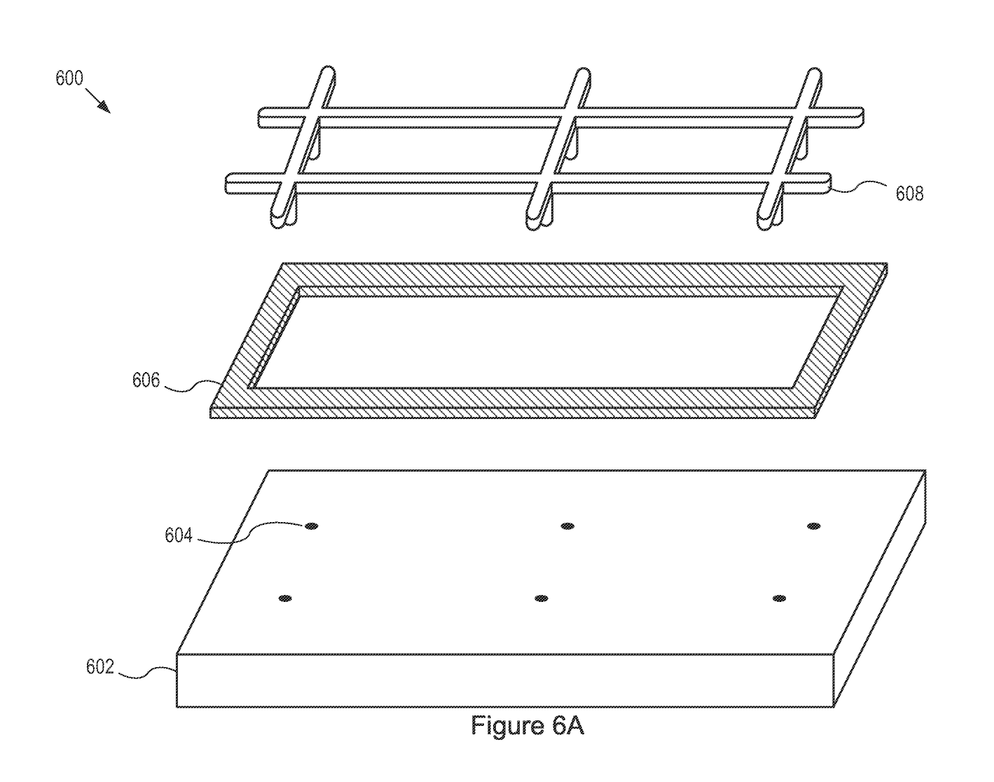

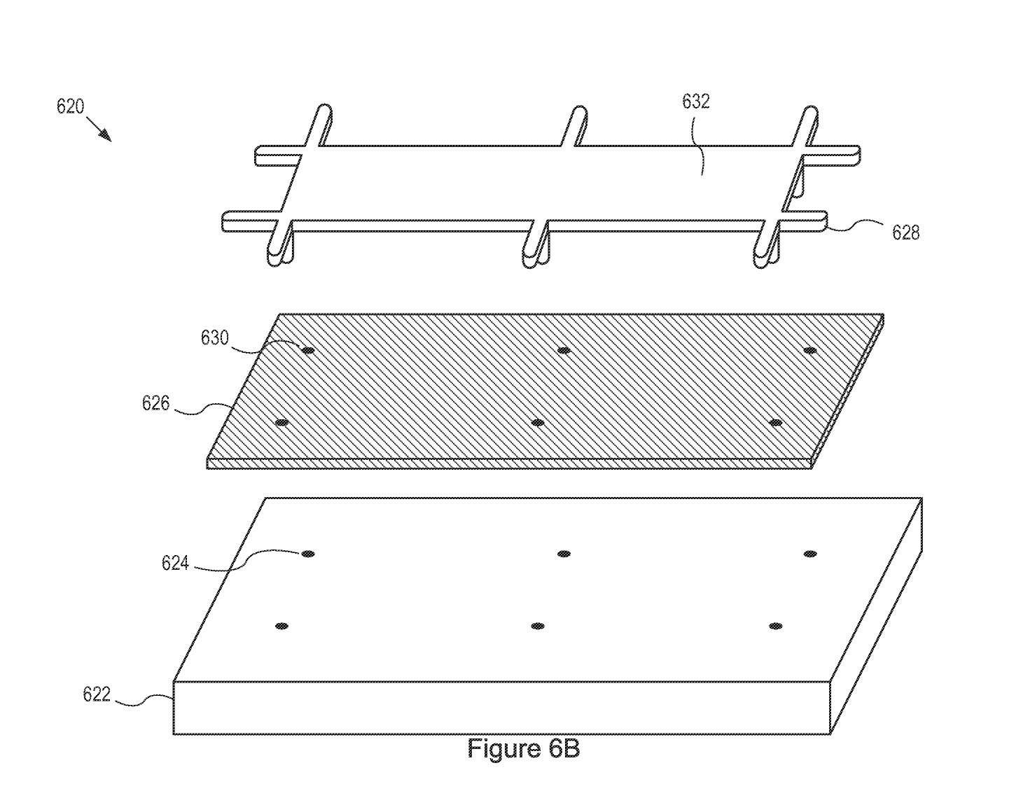

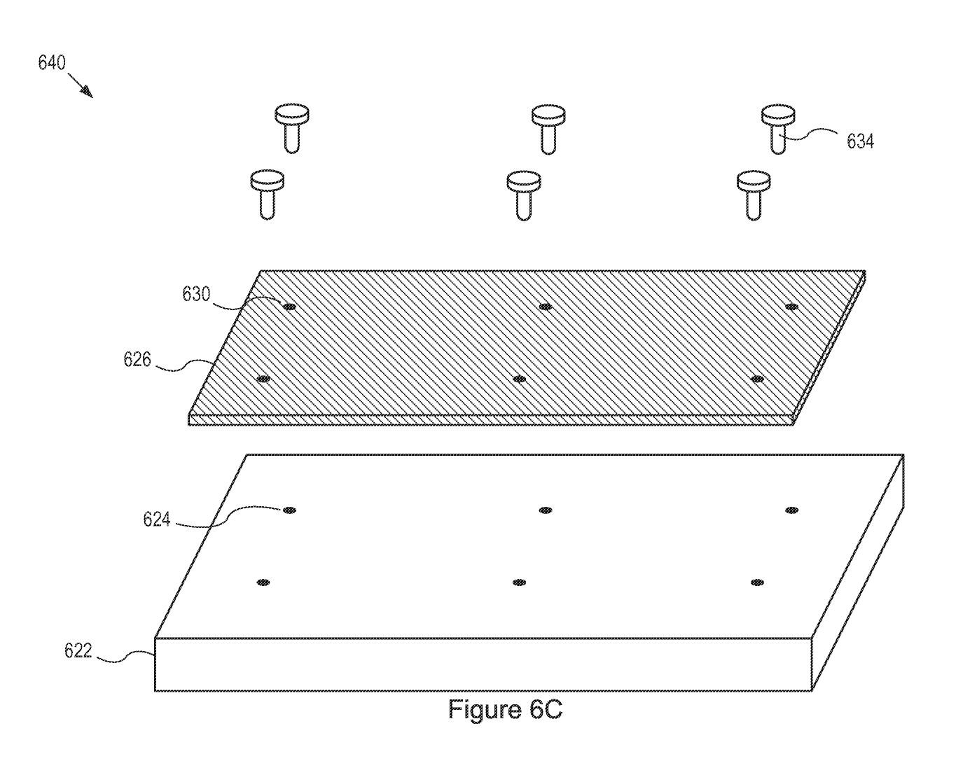

In some embodiments, at least a portion of the bottom surface of the one or more evaporators is exposed. For example, at least a portion of the bottom surface of the one or more evaporators is covered. In some embodiments, at least 25% of the bottom surface of the one or more evaporators is exposed to air. In some embodiments, at least 50% of the bottom surface of the one or more evaporators is exposed to air. In some embodiments, at least 75% of the bottom surface of the one or more evaporators is exposed. In some embodiments, the lid includes one or more screens located adjacent to the bottom surface of the cover plate, and the one or more screens cover at least a portion of the bottom surface of the one or more evaporators. This is described below with respect to FIG. 6B.

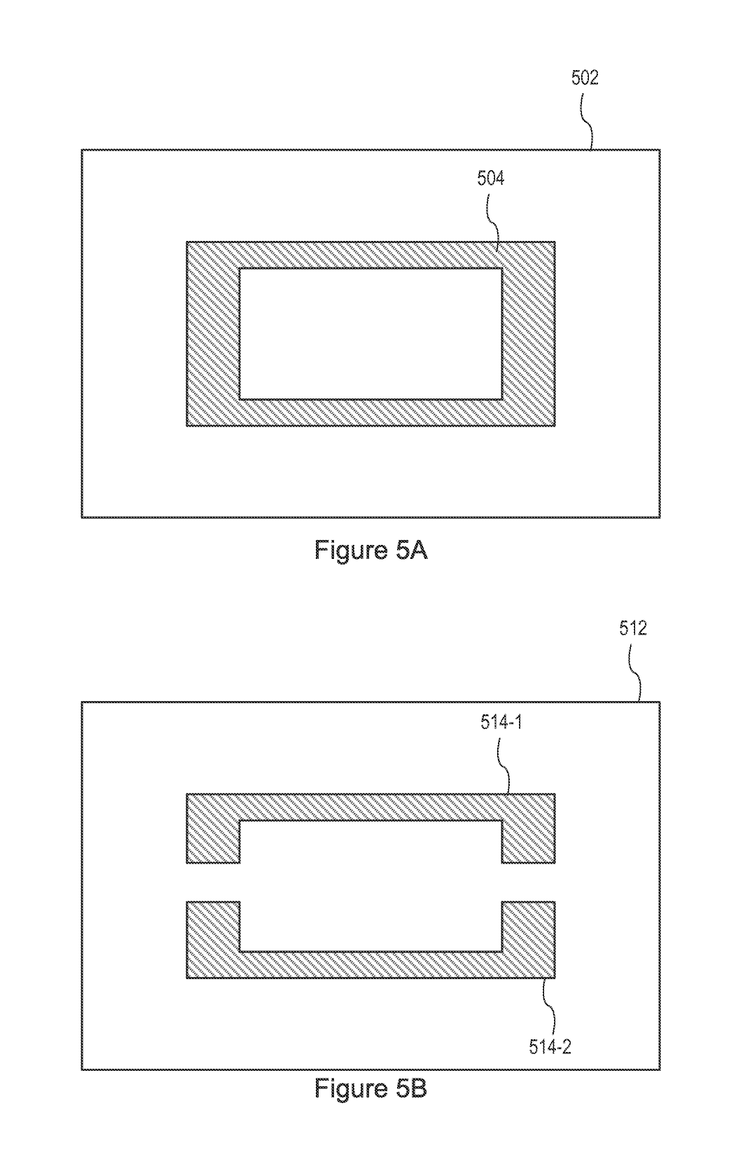

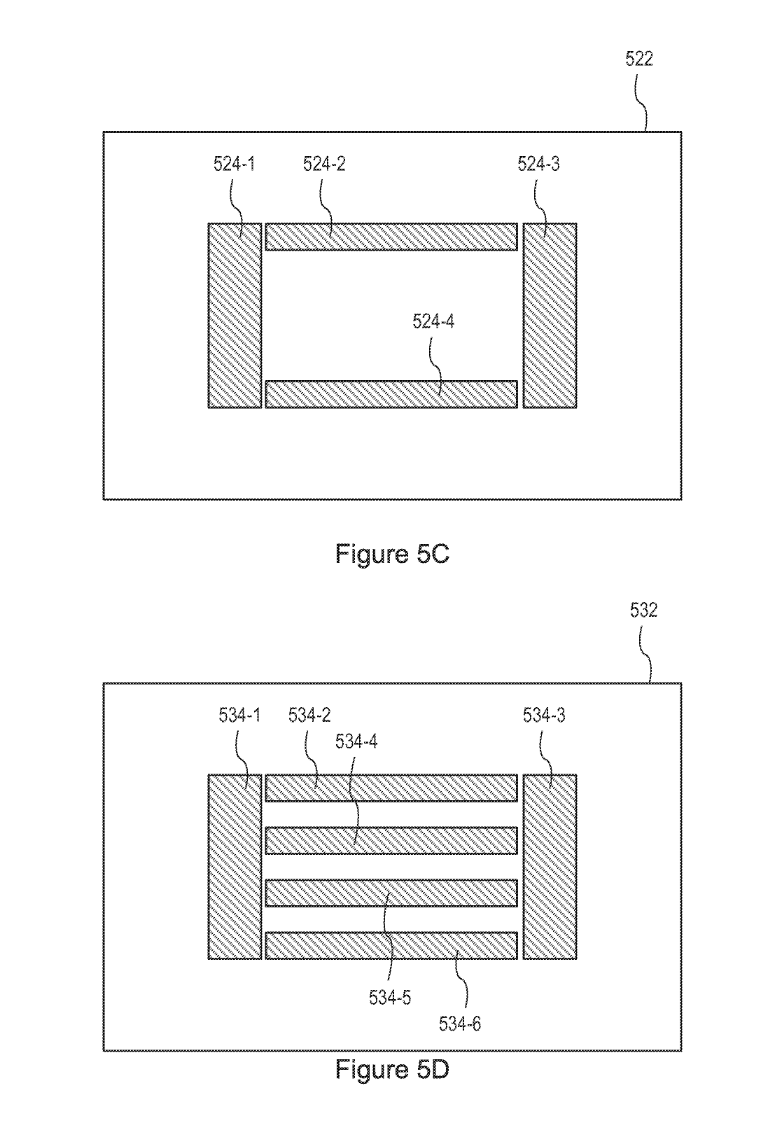

FIGS. 5A-5D are bottom views of exemplary lids in accordance with some embodiments.

FIG. 5A illustrates a lid 502 that includes a single evaporator 504 in accordance with some embodiments.

FIG. 5B illustrates a lid 512 that includes two evaporators 514-1 and 514-2 in accordance with some embodiments.

FIG. 5C illustrates a lid 522 that includes four evaporators 524-1, 524-2, 524-3, and 524-4 in accordance with some embodiments.

FIG. 5D illustrates a lid 532 that includes six evaporators 534-1, 534-2, 534-3, 534-4, 534-5, and 534-6 in accordance with some embodiments.

FIG. 6A is an exploded view of an exemplary lid 600 in accordance with some embodiments. In FIG. 6A, the lid 600 includes a cover plate 602 with one or more holes 604. The lid 600 also includes one or more evaporators (e.g., evaporator 606). The lid 600 also includes a grid 608.

In some embodiments, a method for assembling a lid for controlling evaporation of liquid aliquots includes providing a cover plate (e.g., cover plate 602) configured to cover at least a portion of a sample plate. The cover plate has a bottom surface that is configured to face a sample plate. The method also includes coupling one or more evaporators (e.g., evaporator 606) to the bottom surface of the cover plate. Each evaporator of the one or more evaporators includes absorbent material. The one or more evaporators define one or more exclusion areas on the bottom surface of the cover plate. Each exclusion area is exposed from the one or more evaporators.

In some embodiments, the cover plate 602 is configured to couple with the grid 608. For example, the cover plate 604 has one or more holes 604. Coupling the one or more evaporators to the bottom surface of the cover plate includes coupling the one or more evaporators to the bottom surface of the cover plate with the grid 608. For example, a leg of the grid 608 is inserted into one or more holes 604 to couple the one or more evaporators 606 to the cover plate 602 (e.g., press the one or more evaporators 606 onto the cover plate 602 and/or hold the one or more evaporators 606 to the cover plate 602). In some embodiments, the grid 608 is in contact with the one or more evaporators 606. Thus, in some embodiments, the one or more evaporators 606 are attached to the cover plate 604 by the grid 608.

In some embodiments, the cover plate 602 is configured to removably couple with the grid 608. For example, the one or more holes 604 and the legs of the grid 608 are configured to couple based on friction. For example, in some embodiments, a diameter of a hole 604 and a diameter of a leg are selected to hold the leg when the leg is inserted into the hole 604. In some embodiments, one or both of the leg and the hole 604 are configured to have a latching mechanism. In some embodiments, the cover plate 602 is configured to couple with a removable grid 608, and the removable grid 608 is in contact with the one or more evaporators 606 when the removable grid 608 is coupled with the cover plate 602.

Although FIG. 6A illustrates that the one or more evaporators are attached to the cover plate 604 by a single integrated grid, a person having skill in the art would understand that more than one grid may be used. Thus, in some embodiments, the cover plate 602 is configured to couple with a plurality of discrete grids, and the plurality of discrete grids is configured to attach the one or more evaporators 606 to the cover plate 604. For example, in some embodiments, a single evaporator is attached to the cover plate 604 with four discrete grids each positioned at a respective corner or side of the single evaporator. In some embodiments, a discrete grid comprises a hook. For example, four hooks, each including a single leg and a single finger, hold an evaporator to the cover plate 604.

FIG. 6B is an exploded view of an exemplary lid 620 in accordance with some embodiments. In FIG. 6B, the lid 620 includes a cover plate 622 with one or more holes 624. The cover plate 622 is similar to the cover plate 602 illustrated in FIG. 6A.

In FIG. 6B, the evaporator 626 is configured to cover a substantial portion of a bottom surface of the cover plate 602.

The grid 628 illustrated in FIG. 6B includes a screen 632. Thus, when the grid 628 is coupled with the evaporator 626 and the cover plate 622, the screen 632 covers at least a portion of the bottom surface of the evaporator 626.

Thus, in some embodiments, a lid 620 includes a cover plate 622 configured to cover at least a portion of a sample plate. The cover plate 622 has a bottom surface configured to face the sample plate. The lid 620 also includes one or more evaporators 626 coupled to the bottom surface of the cover plate 622. Each evaporator 626 of the one or more evaporators includes absorbent material. The lid 620 further includes one or more screens 632 located adjacent to the bottom surface of the cover plate 622. The one or more screens 632 cover at least a portion of the bottom surface of the one or more evaporators 630.

FIG. 6C is an exploded view of an exemplary lid 640 in accordance with some embodiments. In FIG. 6C, the lid 640 includes the cover plate 622 with one or more holes 624 described above with respect to FIGS. 6A and 6B.

In FIG. 6C, the cover plate 622 is configured to couple with a plurality of pins 634. Coupling the one or more evaporators to the bottom surface of the cover plate includes coupling the one or more evaporators to the bottom surface of the cover plate with the plurality of pins 634. For example, a portion of the pin 634 is inserted into one or more holes 624 to couple the one or more evaporators 626 to the cover plate 622 (e.g., press the one or more evaporators 626 onto the cover plate 622 and/or hold the one or more evaporators 626 to the cover plate 622). In some embodiments, the plurality of pins 634 is in contact with the one or more evaporators 626. Thus, in some embodiments, the one or more evaporators 626 are attached to the cover plate 624 by the pins 634.

In some embodiments, the cover plate 622 is configured to removably couple with the plurality of pins 634. For example, the one or more holes 624 and the plurality of pins 634 are configured to couple based on friction. For example, in some embodiments, a diameter of a hole 624 and a diameter of a pin 634 are selected to hold the pin 634 when the pin 634 is inserted into the hole 624. In some embodiments, one or both of the pin 634 and the hole 624 are configured to have a latching mechanism.

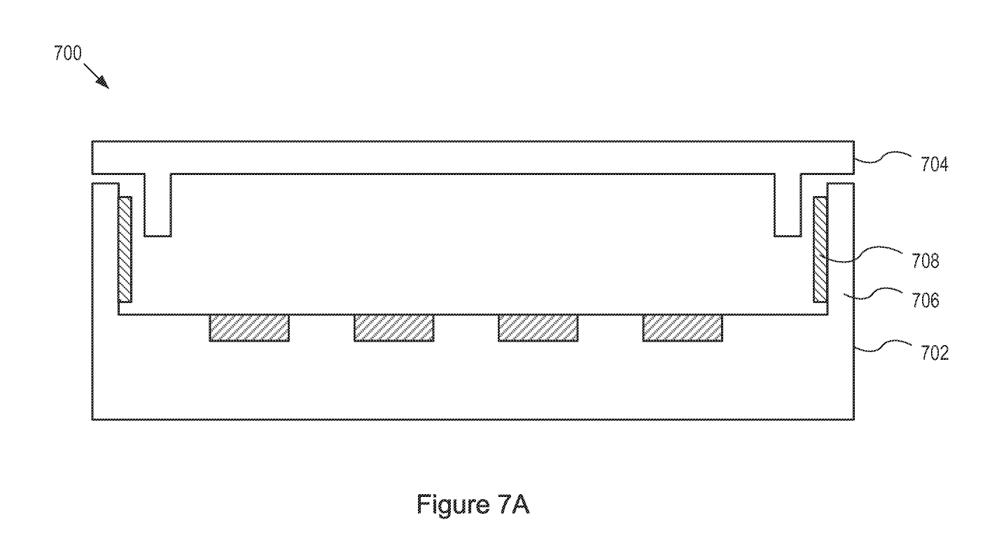

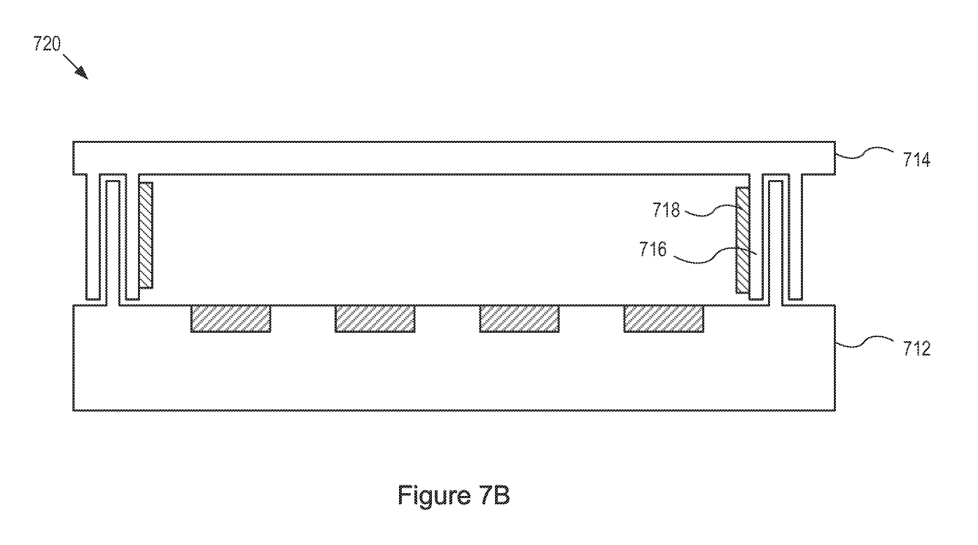

FIG. 7A is a cross sectional view of an exemplary combination of a sample plate 702 and a lid 704 in accordance with some embodiments.

FIG. 7A illustrates that one or more evaporators (e.g., evaporator 708) are attached to one or more side walls (e.g., side wall 706) of a sample plate 702. In some embodiments, the one or more evaporators are coupled to one or more inner side walls of the sample plate 702. In FIG. 7A, the lid 704 does not include an evaporator. In some other embodiments, each of the sample plate 702 and the lid 704 has one or more evaporators.

FIG. 7B is a cross sectional view of an exemplary combination of a sample plate 712 and a lid 714 in accordance with some embodiments.

FIG. 7B illustrates that one or more evaporators (e.g., evaporator 718) are attached to one or more side walls (e.g., side wall 716) of a lid 714. In some embodiments, the lid has one or more inner side walls and one or more outer side walls, and has one or more evaporators coupled to the one or more inner side walls. As used herein, the one or more inner side walls include one or more ribs that extend vertically from a cover plate of the lid 714 but do not form a complete wall. In some embodiments, the one or more evaporators are coupled to inner surfaces of the one or more side walls 716 of the lid 714. In some embodiments, each of the sample plate 712 and the lid 714 has one or more evaporators.

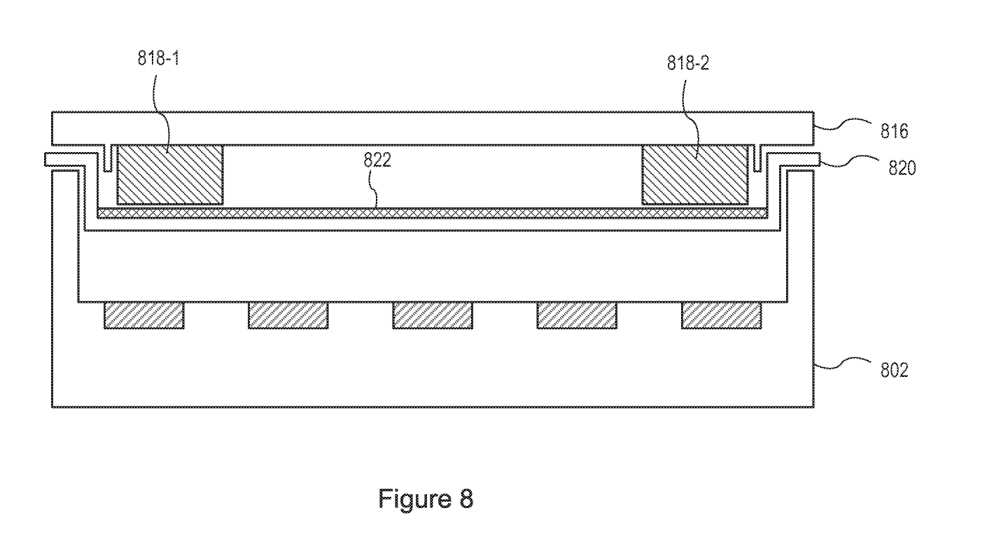

FIG. 8 is a cross sectional view of an exemplary combination of a sample plate 802, a lid 816, and an applicator device 820 in accordance with some embodiments.

The sample plate 802 and the lid 816 are similar to the sample plate 200 and the lid 216 described above with respect to FIG. 3A. The description of the sample plate 802 and the lid 816 is not repeated herein for brevity.

The applicator device 820 includes one or more absorbent pads 822 sized and positioned to contact the one or more evaporators (e.g., evaporators 818-1 and 818-2) of the lid 816 when the applicator device 820 is coupled with the lid 816. The applicator device 820 is configured to removably couple with the lid 816. In some embodiments, the one or more absorbent pads 822 include the evaporation solution (e.g., water).

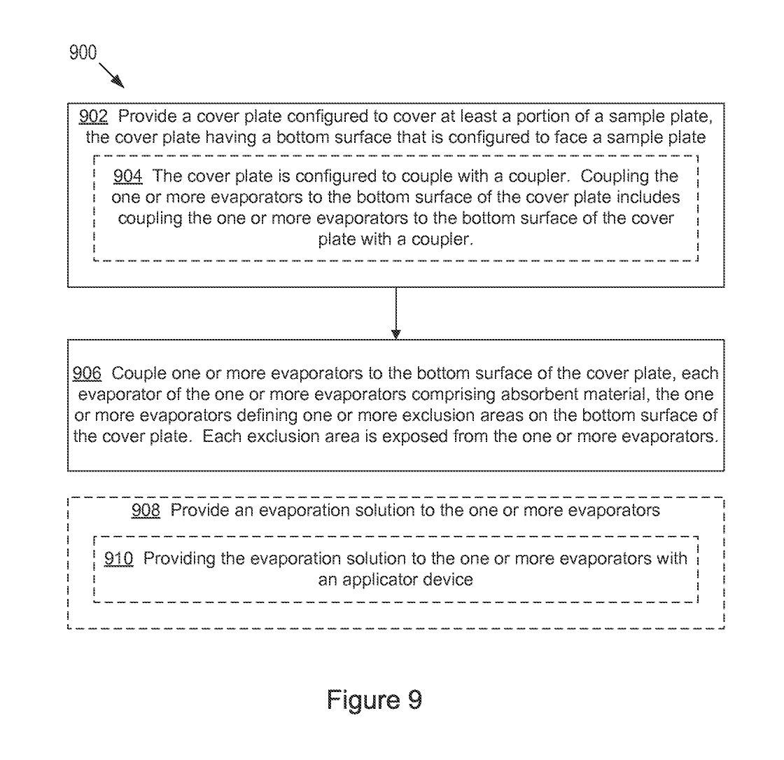

FIG. 9 is a flow chart representing a method 900 of assembling a lid in accordance with some embodiments. In some embodiments, the lid is used for controlling evaporation of liquid aliquots.

The method includes (902) providing a cover plate (e.g., cover plate 602, FIG. 6A) configured to cover at least a portion of a sample plate. The cover plate has a bottom surface that is configured to face a sample plate (e.g., the bottom surface 280 in FIG. 3A).

In some embodiments, the cover plate (e.g., cover plate 602, FIG. 6A) is configured (904) to couple with a coupler (e.g., grid 608, FIG. 6A and/or pins 634, FIG. 6C). Coupling the one or more evaporators to the bottom surface of the cover plate includes coupling the one or more evaporators to the bottom surface of the cover plate with the coupler. For example, the coupler retains the one or more evaporators to the bottom surface of the cover plate.

The method includes (906) coupling one or more evaporators (e.g., evaporator 606, FIG. 6A) to the bottom surface of the cover plate. Each evaporator of the one or more evaporators includes absorbent material. The one or more evaporators define one or more exclusion areas on the bottom surface of the cover plate. Each exclusion area is exposed from the one or more evaporators.

In some embodiments, the method includes (908) providing an evaporation solution to the one or more evaporators (e.g., applying a saline solution to the one or more evaporators). In some embodiments, a predefined amount of the evaporation solution is provided to a respective evaporator.

In some embodiments, the method includes (910) providing the evaporation solution to the one or more evaporators with any applicator device described above (e.g., any applicator device described above with respect to FIG. 8).

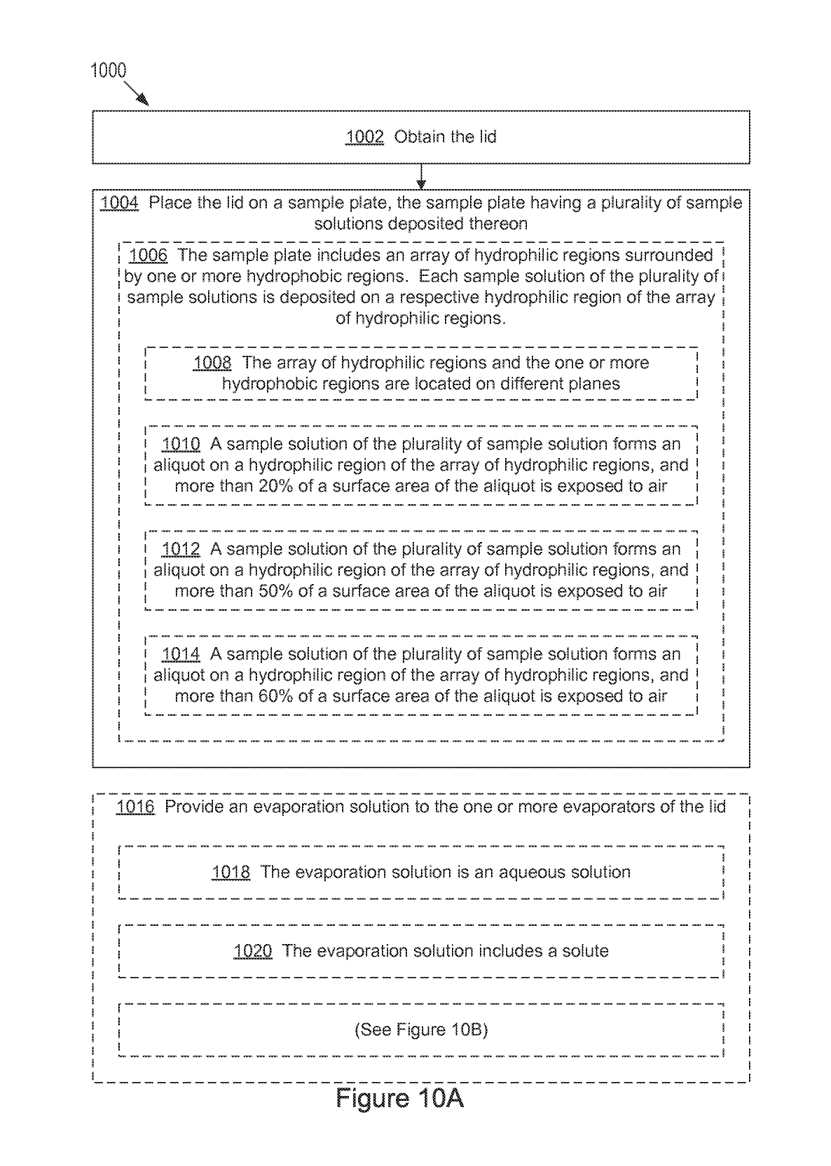

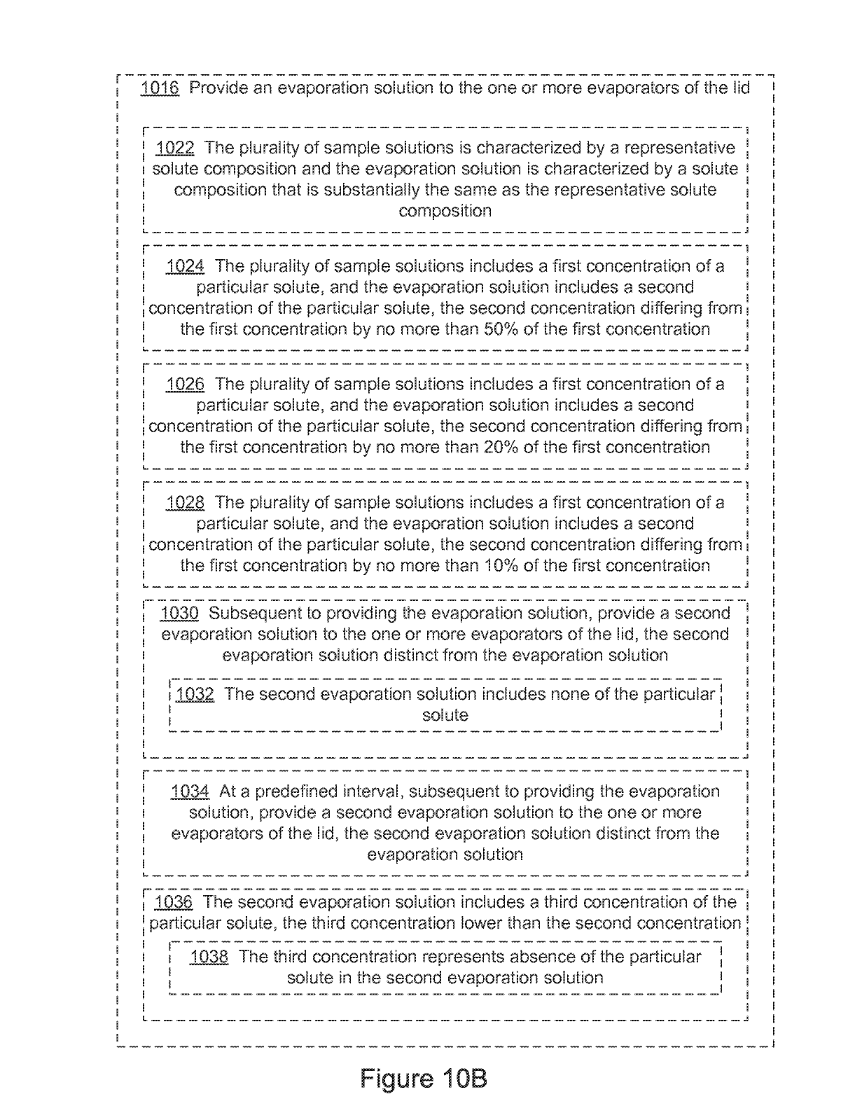

FIGS. 10A and 10B are flow charts representing a method 1000 of using a lid in accordance with some embodiments. In some embodiments, the lid is any lid described herein.

The method includes (1002) obtaining the lid and (1004) placing the lid on a sample plate. A plurality of sample solutions (e.g., liquid aliquots) deposited on the sample plate. For example, in FIG. 3A, the lid 216 is placed on the sample plate 200 with a plurality of sample solutions.

In some embodiments, the sample plate includes (1006) an array of hydrophilic regions surrounded by one or more hydrophobic regions. Each sample solution of the plurality of sample solutions is deposited on a respective hydrophilic region of the array of hydrophilic regions.

In some embodiments, the array of hydrophilic regions and the one or more hydrophobic regions are (1008) located on different planes. For example, in some embodiments, the array of hydrophilic regions define a first plane, the one or more hydrophobic regions define a second plane, and the first plane and the second plane are substantially parallel and separated by 5 mm or less. In some embodiments, the first plane and the second plane are separated by 2 mm or less.

In some embodiments, the array of hydrophilic regions and the one or more hydrophobic regions are located on a same plane.

In some embodiments, a sample solution of the plurality of sample solution forms (1010) an aliquot on a hydrophilic region of the array of hydrophilic regions, and more than 20% of a surface area of the aliquot is exposed to air.

In some embodiments, a sample solution of the plurality of sample solution forms (1012) an aliquot on a hydrophilic region of the array of hydrophilic regions, and more than 50% of a surface area of the aliquot is exposed to air.

In some embodiments, a sample solution of the plurality of sample solution forms (1014) an aliquot on a hydrophilic region of the array of hydrophilic regions, and more than 60% of a surface area of the aliquot is exposed to air.

In some embodiments, the method includes (1016) providing an evaporation solution to the one or more evaporators of the lid.

In some embodiments, the evaporation solution is (1018) an aqueous solution.

In some embodiments, the evaporation solution includes (1020) a solute. In some embodiments, the solute is non-volatile. In some embodiments, the solute affects a vapor pressure of the evaporation solution.

In some embodiments, the plurality of sample solutions is (1022, FIG. 10B) characterized by a representative solute composition and the evaporation solution is characterized by a solute composition that is substantially the same as the representative solute composition. For example, if a sample solution is based on phosphate-buffered saline, the evaporation solution is a phosphate-buffered saline solution. In some embodiments, a vapor pressure of the sample solutions is substantially the same as a vapor pressure of the evaporation solution.

In some embodiments, the plurality of sample solutions includes (1024) a first concentration of a particular solute, and the evaporation solution includes a second concentration of the particular solute. The second concentration differs from the first concentration by no more than 50% of the first concentration. For example, both a sample solution and the evaporation solution may be phosphate-buffered saline solutions, but their concentrations need not be identical.

In some embodiments, the plurality of sample solutions includes (1026) a first concentration of a particular solute, and the evaporation solution includes a second concentration of the particular solute, the second concentration differing from the first concentration by no more than 20% of the first concentration.

In some embodiments, the plurality of sample solutions includes (1028) a first concentration of a particular solute, and the evaporation solution includes a second concentration of the particular solute, the second concentration differing from the first concentration by no more than 10% of the first concentration.

In some embodiments, the method includes (1030), subsequent to providing the evaporation solution, providing a second evaporation solution to the one or more evaporators of the lid, the second evaporation solution distinct from the evaporation solution.

In some embodiments, the second evaporation solution includes (1032) none of the particular solute.

In some embodiments, the method includes (1034), at a predefined interval, subsequent to providing the evaporation solution, providing a second evaporation solution to the one or more evaporators of the lid, where the second evaporation solution is distinct from the evaporation solution. For example, a concentration of a particular solute in the second evaporation solution may differ from a concentration of the particular solute in the evaporation solution.

In some embodiments, the second evaporation solution includes (1036) a third concentration of the particular solute, the third concentration lower than the second concentration. This is important, because the concentration of the particular solute increases with evaporation of the evaporation solution. Adding to the one or more evaporators the second evaporation solution that has the same concentration of the particular solute as the evaporation solution after the evaporation solution has at least partially evaporated increases the concentration of the particular solute in a solution retained by the one or more evaporators, because the particular solute continues to accumulate in the one or more evaporators. The increased concentration of the particular solute changes the vapor pressure of the solution retained by the one or more evaporators, which can lead to reduced uniformity.

In some embodiments, the third concentration represents (1038) absence of the particular solute in the second evaporation solution. For example, the second evaporation solution is deionized water.

It is well known to a person having ordinary skill in the art that sample plates and lids can be used in many other biological and chemical reactions. Therefore, such details and specific examples are omitted for brevity.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

In addition, it is to be understood that some embodiments are described as stated in the following clauses:
1. A lid for controlling evaporation of liquid aliquots, the lid comprising:

a cover plate configured to cover at least a portion of a sample plate, the cover plate having a bottom surface configured to face the sample plate; and

one or more evaporators coupled to the bottom surface of the cover plate, each evaporator of the one or more evaporators comprising absorbent material, the one or more evaporators defining one or more exclusion areas on the bottom surface of the cover plate, wherein each exclusion area is exposed from the one or more evaporators.
2. The lid of clause 1, wherein each evaporator of the one or more evaporators is an absorbent pad.
3. The lid of any one of clauses 1-2, wherein the one or more evaporators define a single exclusion area at least in a middle portion of the bottom surface of the cover plate.
4. The lid of any one of clauses 1-3, wherein the one or more evaporators define a single exclusion area at a location that corresponds to a middle portion of the sample plate.
5. The lid of any one of clauses 1-4, wherein the lid includes only one evaporator that has a through-hole defining a single exclusion area in a middle portion of the bottom surface of the cover plate.
6. The lid of any one of clauses 2-5, wherein the lid is configured to cover a rectangular sample plate and the single exclusion area is a rectangular area.
7. The lid of any one of clauses 1-6, wherein the one or more evaporators are positioned along a periphery of the bottom surface of the cover plate.
8. The lid of any one of clauses 1-7, wherein each evaporator of the one or more evaporators comprises water absorbent material.
9. The lid of any one of clauses 1-8, wherein each evaporator of the one or more evaporators has a top surface facing the cover plate and an exposed bottom surface opposite to the top surface.
10. The lid of clause 9, wherein the bottom surface of the one or more evaporators is fully exposed to air.
11. The lid of clause 9, wherein at least 25% of the bottom surface of the one or more evaporators is exposed to air.
12. The lid of clause 9, wherein at least 50% of the bottom surface of the one or more evaporators is exposed to air.
13. The lid of clause 9, wherein at least 75% of the bottom surface of the one or more evaporators is exposed.
14. The lid of any one of clauses 11-13, further comprising one or more screens located adjacent to the bottom surface of the cover plate, the one or more screens covering at least a portion of the bottom surface of the one or more evaporators.
15. The lid of any one of clauses 1-14, wherein at least one exclusion area of the one or more exclusion areas is located adjacent to a center of the bottom surface of the cover plate.
16. The lid of any one of clauses 1-15, wherein at least one exclusion area of the one or more exclusion areas is located along, and adjacent to, a periphery of the bottom surface of the cover plate.
17. The lid of any one of clauses 1-16, wherein the one or more evaporators are configured to avoid, when the lid is placed on the sample plate, a contact with the sample plate.
18. The lid of any one of clauses 1-17, wherein at least a portion of the cover plate is transparent.
19. The lid of any one of clauses 1-18, wherein the cover plate defines one or more through-holes, each through-hole extending from a top surface, opposite to the bottom surface, of the cover plate to the bottom surface of the cover plate and coupled to at least a portion of an evaporator of the one or more evaporators.
20. The lid of clause 19, wherein the one or more through-holes are positioned along a periphery of the cover plate.
21. The lid of any one of clauses 19-20, wherein the one or more through-holes are positioned adjacent to a corner of the cover plate.
22. The lid of any one of clauses 19-21, further comprising one or more barriers on the top surface of the cover plate configured to cover the one or more through-holes.
23. The lid of any one of clauses 1-22, further comprising a coupler, the coupler being in contact with the one or more evaporators.
24. The lid of any one of clauses 1-22, wherein the cover plate is configured to couple with a removable coupler, wherein the removable coupler is in contact with the one or more evaporators when the removable coupler is coupled with the cover plate.
25. The lid of any one of clauses 1-24, wherein each evaporator of the one or more evaporators comprises one or more of cellulose, paper, cotton, polyvinyl alcohol, hydrogel, polyacrylamide gel, polyurethane, and agarose gel.
26. A lid for controlling evaporation of liquid aliquots, the lid comprising:

a cover plate configured to cover at least a portion of a sample plate, the cover plate having a bottom surface configured to face the sample plate;

one or more evaporators coupled to the bottom surface of the cover plate, each evaporator of the one or more evaporators comprising absorbent material; and

one or more screens located adjacent to the bottom surface of the cover plate, the one or more screens covering at least a portion of the bottom surface of the one or more evaporators.
27. A lid configured for use with a sample plate that includes one or more side walls and one or more inner walls, the lid comprising:

a cover plate configured to cover at least a portion of a sample plate, the cover plate having a bottom surface configured to face the sample plate and one or more contact portions configured to contact with the sample plate when the lid is placed on the sample plate; and

one or more evaporators coupled to the bottom surface of the cover plate, each evaporator of the one or more evaporators comprising absorbent material, wherein a vertical distance between a respective contact portion of the one or more contact portions and the bottom surface of the cover plate satisfy predefined criteria.
28. The lid of clause 27, wherein the predefined criteria are satisfied when the vertical distance is 2 mm or more.
29. The lid of clause 27, wherein the predefined criteria are satisfied when the vertical distance is 5 mm or more.
30. A combination of a lid and a sample plate, the combination including:

a sample plate that includes one or more side walls and one or more inner walls; and

a lid that includes a cover plate, one or more contact portions configured to contact with the sample plate when the lid is placed on the sample plate, and one or more evaporators coupled to the bottom surface of the cover plate, each evaporator of the one or more evaporators comprising absorbent material, wherein a distance between a top surface of the one or more inner walls of the sample plate and the bottom surface of the cover plate satisfy predefined criteria.
31. The combination of clause 30, wherein the predefined criteria are satisfied when the vertical distance is 2 mm or more.
32. The combination of clause 30, wherein the predefined criteria are satisfied when the vertical distance is 5 mm or more.
33. An applicator device for providing a evaporation solution to the lid of any one of clauses 1-32, the applicator device comprising:

one or more absorbent pads sized and positioned to contact the one or more evaporators of the lid when the applicator device is coupled with the lid, wherein the applicator device is configured to removably couple with the lid.
34. The applicator device of clause 33, wherein the one or more absorbent pads include the evaporation solution.
35. A method of assembling a lid for controlling evaporation of liquid aliquots, the method comprising:

providing a cover plate configured to cover at least a portion of a sample plate, the cover plate having a bottom surface that is configured to face a sample plate; and

coupling one or more evaporators to the bottom surface of the cover plate, each evaporator of the one or more evaporators comprising absorbent material, the one or more evaporators defining one or more exclusion areas on the bottom surface of the cover plate, wherein each exclusion area is exposed from the one or more evaporators.
36. The method of clause 35, wherein:

the cover plate is configured to couple with a coupler; and

coupling the one or more evaporators to the bottom surface of the cover plate includes coupling the one or more evaporators to the bottom surface of the cover plate with a coupler.
37. The method of any one of clauses 35-36, further comprising:

providing an evaporation solution to the one or more evaporators.
38. The method of clause 37, including providing the evaporation solution to the one or more evaporators with the applicator device of any one of clauses 33-34.
39. A method of using the lid of any one of clauses 1-32, comprising:

obtaining the lid; and

placing the lid on a sample plate, a plurality of sample solutions deposited on the sample plate.
40. The method of clause 39, wherein the sample plate includes an array of hydrophilic regions surrounded by one or more hydrophobic regions, wherein each sample solution of the plurality of sample solutions is deposited on a respective hydrophilic region of the array of hydrophilic regions.
41. The method of clause 40, wherein the array of hydrophilic regions and the one or more hydrophobic regions are located on different planes.
42. The method of clause 40, wherein a sample solution of the plurality of sample solution forms an aliquot on a hydrophilic region of the array of hydrophilic regions, and more than 20% of a surface area of the aliquot is exposed to air.
43. The method of clause 40, wherein a sample solution of the plurality of sample solution forms an aliquot on a hydrophilic region of the array of hydrophilic regions, and more than 50% of a surface area of the aliquot is exposed to air.
44. The method of clause 40, wherein a sample solution of the plurality of sample solution forms an aliquot on a hydrophilic region of the array of hydrophilic regions, and more than 60% of a surface area of the aliquot is exposed to air.
45. The method of any one of clauses 39-44, further comprising:
   providing an evaporation solution to the one or more evaporators of the lid.
46. The method of clause 45, wherein the evaporation solution is an aqueous solution.
47. The method of any one of clauses 45-46, wherein the evaporation solution includes a solute.
48. The method of any one of clauses 45-47, wherein the plurality of sample solutions is characterized by a representative solute composition and the evaporation solution is characterized by a solute composition that is substantially the same as the representative solute composition.
49. The method of any one of clauses 45-47, wherein the plurality of sample solutions includes a first concentration of a particular solute, and the evaporation solution includes a second concentration of the particular solute, the second concentration differing from the first concentration by no more than 50% of the first concentration.
50. The method of any one of clauses 45-47, wherein the plurality of sample solutions includes a first concentration of a particular solute, and the evaporation solution includes a second concentration of the particular solute, the second concentration differing from the first concentration by no more than 20% of the first concentration.
51. The method of any one of clauses 45-47, wherein the plurality of sample solutions includes a first concentration of a particular solute, and the evaporation solution includes a second concentration of the particular solute, the second concentration differing from the first concentration by no more than 10% of the first concentration.
52. The method of any one of clauses 45-51, further comprising:

subsequent to providing the evaporation solution, providing a second evaporation solution to the one or more evaporators of the lid, the second evaporation solution distinct from the evaporation solution.
53. The method of any one of clauses 45-51, further comprising:

at a predefined interval, subsequent to providing the evaporation solution, providing a second evaporation solution to the one or more evaporators of the lid, the second evaporation solution distinct from the evaporation solution.
54. The method of any one of clauses 52-53, wherein the second evaporation solution includes a third concentration of the particular solute, the third concentration lower than the second concentration.
55. The method of clause 54, wherein the third concentration represents absence of the particular solute in the second evaporation solution.
56. The method of any one of clauses 52-53, wherein the second evaporation solution includes none of the particular solute.
57. A sample plate, comprising:

one or more side walls configured to couple with the lid of any one of claims 1-32; and

one or more inner walls configured such that a distance between the one or more inner walls and the lid satisfies predefined criteria.
58. The sample plate of clause 57, wherein the distance between the one or more inner walls and the lid is 2 mm or more.
59. The sample plate of any of clauses 57-58, wherein the distance between the one or more inner walls and the lid is 5 mm or more.
60. The sample plate of any of clauses 57-59, wherein a height of the one or more inner walls is less than a height of the one or more side walls.

1.-8. (canceled)

9. A lid for controlling evaporation of liquid aliquots, the lid comprising:
a cover plate configured to cover at least a portion of a sample plate, the cover plate having a bottom surface configured to face the sample plate; and
one or more evaporators coupled to the bottom surface of the cover plate, each evaporator of the one or more evaporators comprising absorbent material, the one or more evaporators defining one or more exclusion areas on the bottom surface of the cover plate, wherein each exclusion area is exposed from the one or more evaporators, wherein each evaporator of the one or more evaporators has a top surface facing the cover plate and an exposed bottom surface opposite to the top surface.

10.-16. (canceled)

17. The lid of claim 9, wherein the one or more evaporators are configured to avoid, when the lid is placed on the sample plate, a contact with the sample plate.

18.-23. (canceled)

24. The lid of claim 9, wherein the cover plate is configured to couple with a removable coupler, wherein the removable coupler is in contact with the one or more evaporators when the removable coupler is coupled with the cover plate.

25. (canceled)

26. A lid for controlling evaporation of liquid aliquots, the lid comprising:
a cover plate configured to cover at least a portion of a sample plate, the cover plate having a bottom surface configured to face the sample plate;
one or more evaporators coupled to the bottom surface of the cover plate, each evaporator of the one or more evaporators comprising absorbent material; and
one or more screens located adjacent to the bottom surface of the cover plate, the one or more screens covering at least a portion of the bottom surface of the one or more evaporators.

27. A lid configured for use with a sample plate that includes one or more side walls and one or more inner walls, the lid comprising:
a cover plate configured to cover at least a portion of a sample plate, the cover plate having a bottom surface configured to face the sample plate and one or more contact portions configured to contact with the sample plate when the lid is placed on the sample plate; and
one or more evaporators coupled to the bottom surface of the cover plate, each evaporator of the one or more evaporators comprising absorbent material, wherein a vertical distance between a respective contact portion of the one or more contact portions and the bottom surface of the cover plate satisfy predefined criteria.

28. The lid of claim 27, wherein the predefined criteria are satisfied when the vertical distance is 2 mm or more.

29. (canceled)

30. A combination of the lid of claim 9 and a sample plate, the combination including:
a sample plate that includes one or more side walls and one or more inner walls; and
the lid that includes the cover plate, one or more contact portions configured to contact with the sample plate when the lid is placed on the sample plate, and the one or more evaporators coupled to the bottom surface of the cover plate, each evaporator of the one or more evaporators comprising absorbent material, wherein a distance between a top surface of the one or more inner walls of the sample plate and the bottom surface of the cover plate satisfy predefined criteria.

31. The combination of claim 30, wherein the predefined criteria are satisfied when the vertical distance is 2 mm or more.

32.-42. (canceled)

43. The method of claim 45, wherein:
the sample plate includes an array of hydrophilic regions surrounded by one or more hydrophobic regions;
each sample solution of the plurality of sample solutions is deposited on a respective hydrophilic region of the array of hydrophilic regions; and
a sample solution of the plurality of sample solution forms an aliquot on a hydrophilic region of the array of hydrophilic regions, and more than 50% of a surface area of the aliquot is exposed to air.

44. (canceled)

45. A method of using the lid of claim 9, comprising:
obtaining the lid;
providing an evaporation solution to the one or more evaporators of the lid; and
placing the lid on a sample plate, a plurality of sample solutions deposited on the sample plate.

46. The method of claim 45, wherein the evaporation solution is an aqueous solution.

47. The method of claim 45, wherein the evaporation solution includes a solute.

48. The method of claim 45, wherein the plurality of sample solutions is characterized by a representative solute composition and the evaporation solution is characterized by a solute composition that is substantially the same as the representative solute composition.

49. The method of claim 45, wherein the plurality of sample solutions includes a first concentration of a particular solute, and the evaporation solution includes a second concentration of the particular solute, the second concentration differing from the first concentration by no more than 50% of the first concentration.

50.-51. (canceled)

52. The method of claim 45, further comprising:
subsequent to providing the evaporation solution, providing a second evaporation solution to the one or more evaporators of the lid, the second evaporation solution distinct from the evaporation solution.

53. The method of claim 45, further comprising:
at a predefined interval, subsequent to providing the evaporation solution, providing a second evaporation solution to the one or more evaporators of the lid, the second evaporation solution distinct from the evaporation solution.

54. The method of claim 52, wherein the second evaporation solution includes a third concentration of the particular solute, the third concentration lower than the second concentration.

55.-56. (canceled)

57. A sample plate, comprising:
one or more side walls configured to couple with the lid of claim 9; and
one or more inner walls configured such that a distance between the one or more inner walls and the lid satisfies predefined criteria.

58. The sample plate of claim 57, wherein the distance between the one or more inner walls and the lid is 2 mm or more.

59. (canceled)

60. The sample plate of claim 57, wherein a height of the one or more inner walls is less than a height of the one or more side walls.
